(19) United States
(12) Patent Application Publication
(10) Pub. No.: US 2015/0063201 A1
(43) Pub. Date: Mar. 5, 2015

(54) METHOD OF FORMING BEAM AND ALLOCATING RESOURCE IN LTE-BASED COMMUNICATION SYSTEM

(71) Applicant: Electronics and Telecommunications Research Institute, Daejeon (KR)

(72) Inventors: Hee Wook KIM, Daejeon (KR); Kunseok KANG, Daejeon (KR); Bon Jun KU, Daejeon (KR); Do-Seob AHN, Daejeon (KR)

(21) Appl. No.: 14/303,027

(22) Filed: Jun. 12, 2014

(30) Foreign Application Priority Data
Aug. 29, 2013 (KR) 10-2013-0103444

(51) Int. Cl. H04W 72/08; H04B 7/185

(52) U.S. Cl. CPC H04W 72/082; H04B 7/18513
USPC 370/316

(57) ABSTRACT

A method of forming a beam and a method of allocating a resource in a long term evolution (LTE)-based mobile communication system are provided. More particularly, a method of forming an adaptive satellite multiple beam for enhancing multiple beam performance and a method of allocating a resource that can relieve interference in a beam that is formed according to the method in a multiple beam system in which satellite communication and mobile communication is coupled based on LTE are provided. When providing a communication service that supports both satellite communication and ground communication, performance degradation can be reduced with the same interface, and by providing a method of forming an adaptive beam and a method of allocating a resource by relieving interference of the formed beam in consideration of a position of the terminal by independently allocating a subcarrier to the terminal and enabling the terminal to process the subcarrier, performance of a multiple beam can be improved.

### CROSS-REFERENCE TO RELATED APPLICATION

This application claims priority to and the benefit of Korean Patent Application No. 10-2013-0103444 filed in the Korean Intellectual Property Office on Aug. 29, 2013, the entire contents of which are incorporated herein by reference.

### BACKGROUND OF THE INVENTION

(a) Field of the Invention

The present invention relates to a method of forming a beam and a method of allocating a resource in a long term evolution (LTE)-based mobile communication system. More particularly, the present invention relates to a method of forming an adaptive satellite multiple beam for enhancing a multiple beam performance and a method of allocating a resource that can relieve interference in a beam that is formed according to the method in a multiple beam system in which satellite communication and mobile communication is coupled based on LTE.

(b) Description of the Related Art

In an LTE-based communication system, a downlink transmitting method uses technology based on an orthogonal frequency division multiplex (OFDM) method.

The OFDM method has a strength in selectivity of a channel frequency due to a relatively long OFDM symbol segment together with a cyclic prefix (CP). When not using an OFDM method, it is necessary to solve signal damage occurring by a frequency selective channel. A method of solving such a problem using an equalizer in some receiving terminals was suggested, but when using a bandwidth larger than 5 MHz, there is a problem that complexity of the equalizer increases.

Therefore, when using a bandwidth larger than 5 MHz, an OFDM method has a large merit.

In an LTE-based communication system, in an uplink transmitting method, for a low peak to average power ratio (PAPR) of a transmitting signal, a discrete Fourier transform spread-orthogonal frequency division multiplex (DFTS-OFDM)-based single-carrier transmitting method is used.

That is, when using a single-carrier transmitting method, a PAPR of a transmitting signal is further lowered and thus average transmitting power of a power amplifier may increase, and this has an effect of enlargement of coverage and decrease of terminal power consumption.

Nowadays, a communication system is innovated into a satellite/ground integration system in which a ground communication network and a satellite communication network can be coupled or cooperated.

Such a satellite/ground integration system has commonality between a satellite interface and a ground interface, and reuses an existing ground terminal and thus has a merit that it can realize economy of scale. Particularly, a next generation international mobile telecommunications-advanced (IMT-Advanced) system is formed in consideration of an LTE-based ground mobile communication system, and thus has the above merit.

That is, in order for a terminal to use both a satellite service and a ground service, a method of reusing an existing ground LTE chipset without necessity to have a dual mode chip is considered.

In a satellite/ground integration system, when a satellite interface and a ground interface are different, by applying an interface that is optimized in a satellite environment to a satellite mobile communication system, there is a merit that overhead of a satellite payload can be reduced.

However, trade-off between performance degradation and economic efficiency occurs.

### SUMMARY OF THE INVENTION

The present invention has been made in an effort to provide a method of forming a beam and a method of allocating a resource in an LTE-based communication system that has the same interface, but that can reduce performance degradation when providing a communication service that supports both satellite communication and ground communication.

The present invention further provides a method of forming a beam and a method of allocating a resource in an LTE-based communication system that can improve performance of a multiple beam by providing a method of forming an adaptive beam and a method of allocating a resource by relieving interference of the formed beam in consideration of a position of the terminal by independently allocating a subcarrier to the terminal and enabling the terminal to process the subcarrier.

An exemplary embodiment of the present invention provides a method in which a satellite base station forms a beam for communication with a terminal and allocates a resource, the method including forming an adaptive beam and allocating a resource for relieving interference when a resource block (RB) is a channel that is allocated to a specific terminal.

The channel that is allocated to the specific terminal may be at least one of a physical downlink shared channel (PDSCH), a physical uplink shared channel (PUSCH), a reference signal (RS), and a physical uplink control channel (PUCCH).

The forming of an adaptive beam may include: determining a position of the terminal; calculating a weight vector that raises performance according to a position of the terminal; and forming a beam by applying the weight vector to the RB.

The performance may be evaluated in consideration of a signal to interference and noise ratio (SINR) or a signal to noise ratio (SNR).

The forming of an adaptive beam may include: dividing an area within a beam using the same frequency; calculating a weight vector that increases performance in the divided area; and forming an adaptive beam in consideration of the weight vector for a terminal that is positioned within the area.

The dividing of an area within a beam may include dividing the area in consideration of terminal distribution or a traffic amount within the beam.

The forming of an adaptive beam may include forming RBs in a group to correspond to the number of the divided areas, and forming an adaptive beam by applying the calculated weight vector to the RBs that are formed in a group.

The forming of an adaptive beam may include: receiving a sounding reference signal (SRS) from the terminal; determining a weight vector and an RB in which an SINR of an uplink signal of the terminal is maximized through the received SRS signal; transmitting information about the RB that is determined through a downlink control channel to the terminal; transmitting data from the terminal to the RB; and receiving an uplink signal through a beam that is formed through the weight vector from the terminal.

The determining of a weight vector and an RB may include determining an RB that can be allocated to the terminal; calculating a maximum SINR and a weight vector that maximizes an SINR of an SRS signal that is received on an RB basis; and preferentially allocating an RB in which the calculated maximum SINR is high to the terminal.

The detailed matters of the exemplary embodiments will be included in the detailed description and the drawings.

According to the present invention, when providing a communication service that supports both satellite communication and ground communication, performance degradation can be reduced with the same interface.

Further, by independently allocating a subcarrier to a terminal and enabling the terminal to process a subcarrier, a method of allocating a resource by forming an adaptive beam and relieving interference of the formed beam in consideration of a position of the terminal is provided and thus performance of a multiple beam can be improved.

### BRIEF DESCRIPTION OF THE DRAWINGS

FIG. 1 is a block diagram illustrating a multiple beam structure for providing a communication service that supports both ground communication and satellite communication through a satellite.

FIG. 2 is a block diagram illustrating formation of a multiple beam that is considered according to an exemplary embodiment of the present invention.

FIG. 3 is a flowchart illustrating a method of forming a beam and allocating a resource according to an exemplary embodiment of the present invention.

FIG. 4 is a block diagram illustrating a downlink frame structure that is allocated to a terminal according to an exemplary embodiment of the present invention.

FIG. 5 is a block diagram illustrating a structure of forming an adaptive beam according to a position of a terminal according to an exemplary embodiment of the present invention.

FIG. 6 is a flowchart illustrating a method of forming a beam according to an exemplary embodiment of the present invention.

FIG. 7 is a block diagram illustrating a structure of a satellite antenna beam forming device according to an exemplary embodiment of the present invention.

FIG. 8 is a flowchart illustrating a method of forming a beam according to another exemplary embodiment of the present invention.

FIG. 9 is a block diagram illustrating a structure of a satellite antenna beam forming device in a multiple beam satellite system according to an exemplary embodiment of the present invention.

FIG. 10 is a block diagram illustrating a structure of a satellite antenna beam forming device in a multiple beam satellite system according to another exemplary embodiment of the present invention.

FIG. 11 is a flowchart illustrating a method of forming a beam according to another exemplary embodiment of the present invention.

FIG. 12 is a flowchart illustrating a method of forming an adaptive beam and allocating a resource in an uplink according to an exemplary embodiment of the present invention.

FIG. 13 is a flowchart illustrating a method of determining a weight vector and an RB in which a satellite base station maximizes an SINR of an uplink signal of a terminal according to an exemplary embodiment of the present invention.

FIG. 14 is a diagram illustrating a multiple beam satellite system that operates by forming an optimal beam in consideration of interference from an adjacent beam or another network according to an exemplary embodiment of the present invention.

### DETAILED DESCRIPTION OF THE EMBODIMENTS

These and other objects of the present application will become more readily apparent from the detailed description given hereinafter together with the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description. Terms used in this specification are not to limit the present invention but to illustrate exemplary embodiments.

The following description illustrates a 3GPP LTE-based personal portable satellite mobile communication system having maximum commonality with a ground system, but the present invention is not limited to such an illustration and can be applied regardless of any ground access specification based on orthogonal frequency-division multiple access (OFDMA), code division multiple access (CDMA), wideband code division multiple access (WCDMA), time division multiple access (TDMA), and frequency division multiple access (FDMA) that are considered in 3GPP, 3GPP2, and IEEE and any satellite access specification that is optimized in a satellite environment in a satellite mobile system using a specific ground auxiliary apparatus such as a repeater, a complementary ground component (CGC), an ancillary terrestrial component (ATC), etc., like Korean satellite DMB and European digital video broadcasting-satellite services to handhelds (DVB-SH).

Further, the present invention can be applied to a downlink of any mobile communication system in which an existing LTE wireless interface cannot have optimal performance in a downlink.

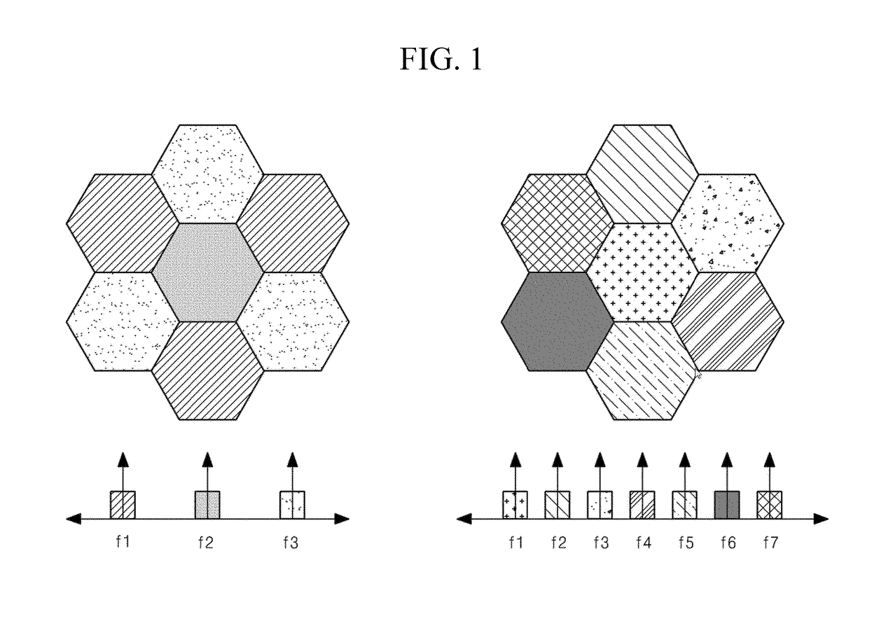

FIG. 1 is a block diagram illustrating a multiple beam structure for providing a communication service that supports both ground communication and satellite communication through a satellite. Referring to FIG. 1, a block diagram that is shown at the left side illustrates a multiple beam structure of frequency reuse 3, and a block diagram that is shown at the right side illustrates a multiple beam structure of frequency reuse 7.

In such two cases, spectrum efficiency is excellent in a multiple beam structure like the block diagram that is shown at the left side that efficiently reuses the smaller number of frequencies, but much interference occurs by a beam using the same frequency.

Therefore, frequency reuse should consider the number of carriers that can be used, throughput of a requested beam, and a satellite beam antenna pattern.

That is, when using a conventionally used fixed beam, a problem that a terminal of a beam boundary area has relatively low signal intensity and is weak in interference by another beam or another network using the same frequency occurs.

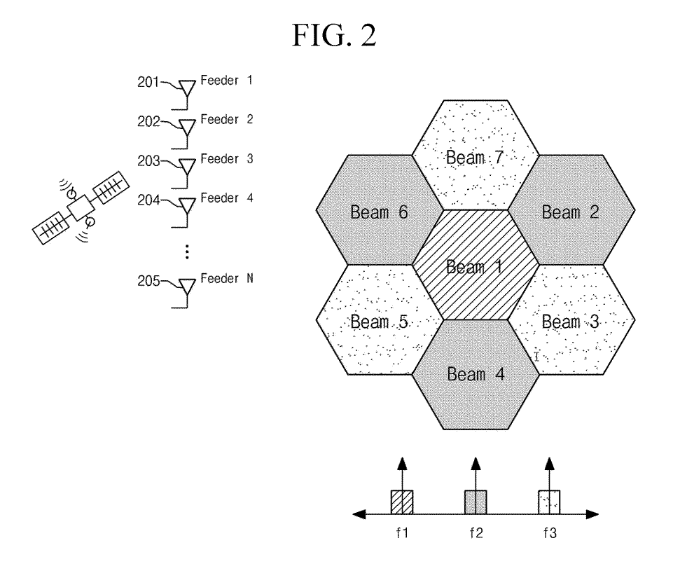

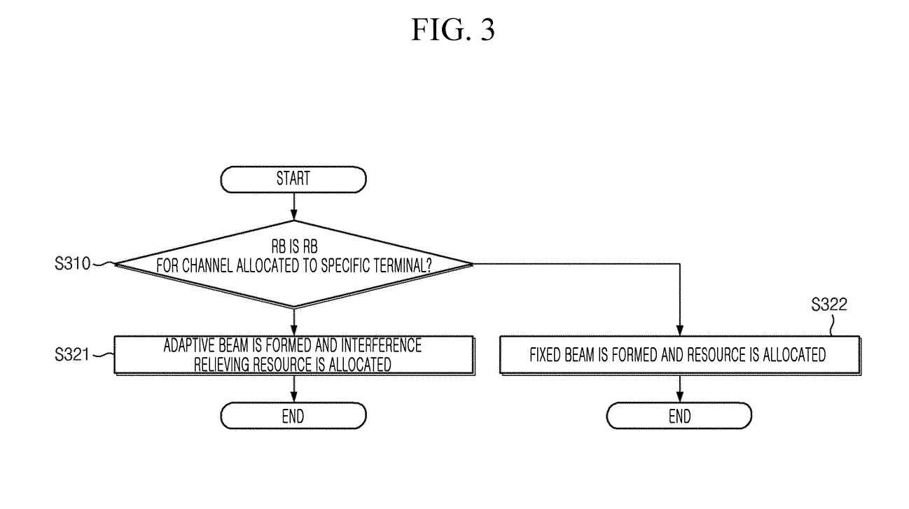

FIG. 2 is a block diagram illustrating formation of a multiple beam that is considered according to an exemplary embodiment of the present invention. FIG. 3 is a flowchart illustrating a method of beam formation and resource allocation according to an exemplary embodiment of the present invention. A multiple beam that is formed as shown in FIG. 2 provides a channel that a user terminal should use to enable communication. For example, a channel that a user terminal should use may be a downlink shared channel (SCH), a physical broadcast channel (PBCH), a physical downlink control channel (PDCCH), a physical control format indicator channel (PCFICH), a physical hybrid-ARQ indicator channel (PHICH), and a uplink physical random access channel (PRACH).

Referring to FIG. 2, the N number of antenna feeders 201, 202, 203, 204, and 205 form a beam 1 using a W₁ vector that is formed with a weighting value W_{1,i} (0<i<N+1) that enables a beam to advance to a beam 1 area. In this way, a beam 2 to a beam 7 may be formed.

In such a case, a terminal in a boundary area of each beam has lower signal intensity than that of a terminal in a beam central area, and may receive interference from another network or another beam that is positioned at a boundary.

Therefore, at a position of each terminal, by forming an optimal beam, adaptive beam formation that can enhance a receiving signal to interference and noise ratio (SINR) of the terminal is requested, and in the present invention, the following method is suggested.

Particularly, the following method is advantageous when applying it to channels that are allocated to a specific terminal, and a channel that is allocated to a specific terminal may be a PDSCH, a PUSCH, an RS, and a PUCCH. Here, the RS channel and the PUCCH may be allocated to a specific terminal or may not be allocated to a specific terminal.

Thereby, a method of forming a beam and allocating a resource according to an exemplary embodiment of the present invention that is described with reference to FIG. 3 is suggested.

That is, it is determined whether the RB is an RB for a channel that is allocated to a specific terminal (S310), and if the RB is an RB for a channel that is allocated to a specific terminal, an adaptive beam is formed and an interference relieving resource is allocated (S321), and if the RB is not an RB for a channel that is allocated to a specific terminal, a fixed beam is formed and a resource is allocated (S322).

As a specific example, a satellite or a base station determines whether the RB is an RB for a PDSCH, a PUSCH, an RS, or a PUCCH, and if the RB is an RB for a PDSCH, a PUSCH, an RS, or a PUCCH, an adaptive beam is formed, and a resource is allocated to relieve interference.

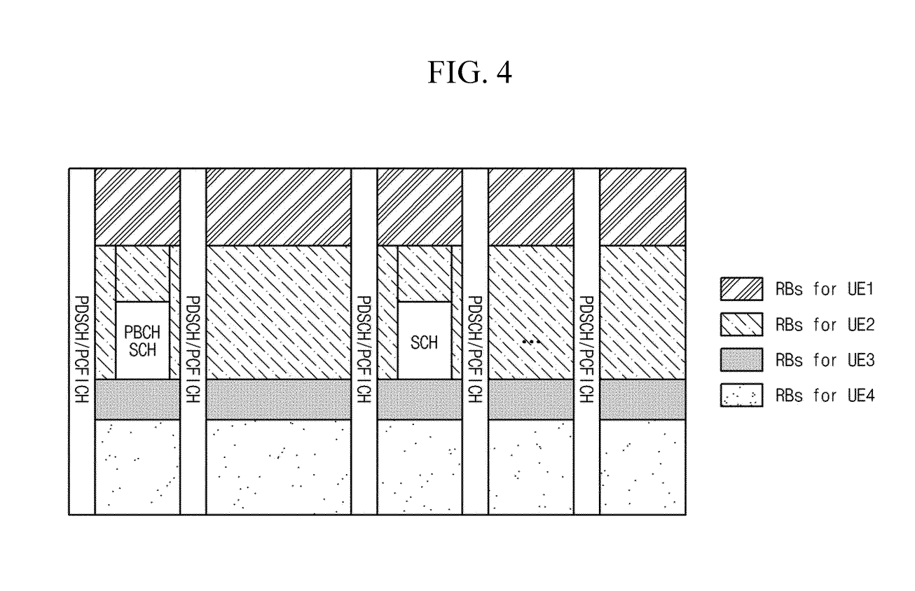

FIG. 4 is a block diagram illustrating a downlink frame structure that is allocated to a terminal according to an exemplary embodiment of the present invention. FIG. 4 illustrates four terminals, an RB is allocated so that each terminal receives allocation of a constant subcarrier within a frame, but in a time axis and a frequency axis, a method of smoothly allocating an RB may be considered.

An LTE-based interface allocates 12, 25, 50, 100, 150, and 200 RBs to each terminal according to a support bandwidth.

Further, preferably, in order to form an optimal beam according to each terminal or a group of a terminal of FIG. 4, an RB that is allocated to the each terminal or the group of the terminal may be formed to independently form an adaptive beam.

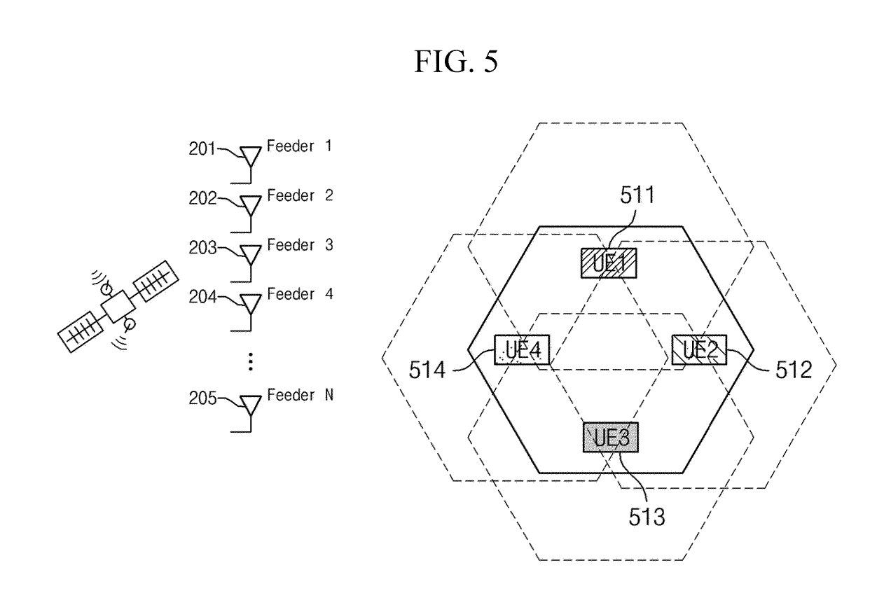

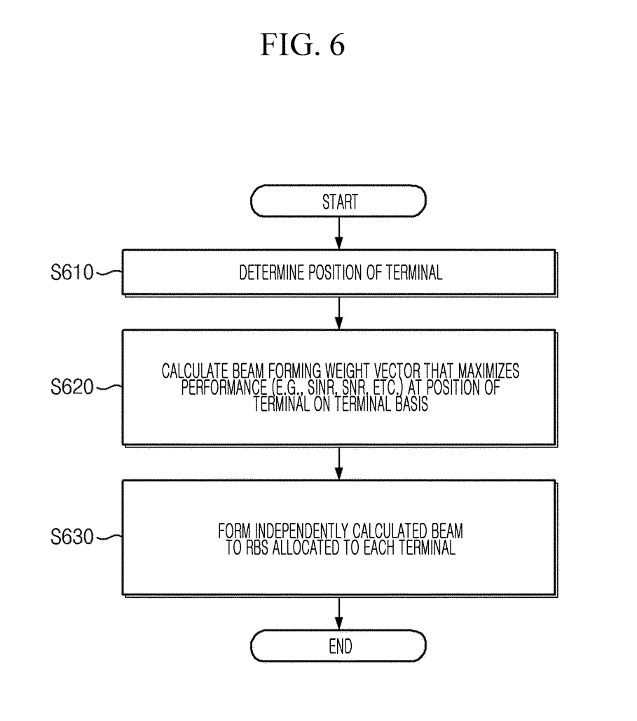

FIG. 5 is a block diagram illustrating a structure of forming an adaptive beam according to a position of the terminal according to an exemplary embodiment of the present invention. FIG. 6 is a flowchart illustrating a method of forming a beam according to an exemplary embodiment of the present invention. FIG. 5 illustrates a case in which a resource is allocated, as shown in FIG. 3 in a beam 1.

Referring to FIG. 5, a first terminal 511 is positioned in an upward boundary area of a beam 1. That is, in order to increase intensity of a signal transmitted and received between the first terminal 511 and the satellite, a beam should be formed so that the first terminal 511 is positioned at the center of the beam. That is, when a weight vector for forming a beam so that the first terminal 511 is positioned at the center of the beam is referred to as W_{1,1}, only a signal that is transmitted to the first terminal 511 should form such a beam and thus a weight vector of W_{1,1,i} (0<i<M−1) is applied to only an RB that is allocated to the first terminal 511.

Similarly, weight vectors W_{1,2}, W_{1,3}, and W_{1,4} may be applied to an RB that is allocated to a second terminal 512, a third terminal 513, and a fourth terminal 514.

Thereby, a method of forming a beam according to another exemplary embodiment of the present invention that is described with reference to FIG. 6 is suggested.

That is, the method includes a step of determining a position of a terminal (S610), a step of calculating a weight vector that can raise performance according to a position of the terminal (S620), and a step of forming a beam by applying a weight vector to an RB that is allocated to each terminal (S630).

Here, as a performance factor, for example, an SINR or an SNR may be considered.

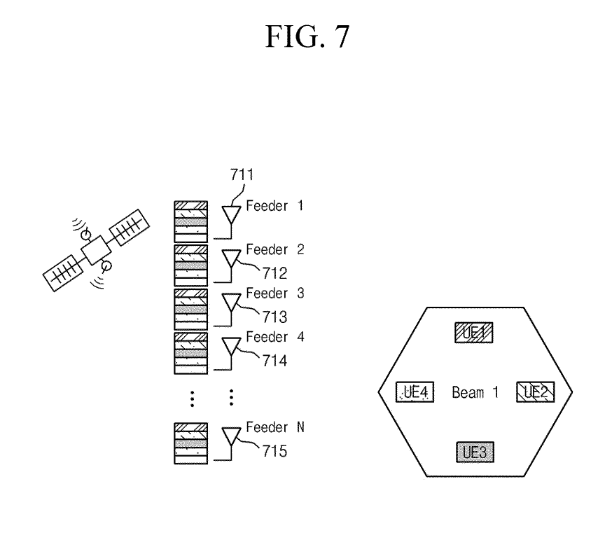

FIG. 7 is a block diagram illustrating a structure of a satellite antenna beam forming device according to an exemplary embodiment of the present invention. FIG. 7 illustrates adaptive beam formation of a beam 1, but even in another beam, an adaptive beam may be similarly formed.

Referring to FIG. 7, the N number of antenna feeders 711, 712, 713, 714, and 715 that receive a communication signal for the beam 1 form a beam when not forming an adaptive beam by applying a weight vector W₁ in consideration of beam 1 coverage when not forming an adaptive beam on each feeder basis.

In an i-th terminal in which a specific RB is allocated, an adaptive beam is formed, and in this case, in order to apply a weight vector W_{1,1} having W_{1,1,i} (0<i<M−1) as an element in consideration of a position of the i-th terminal to the RB, a W′_{1,1} vector in consideration of an existing weight vector W₁ is calculated. The W′_{1,1} vector is extracted from Equation 1.

W′_{1,1}wW₁=W_{1,1} <Equation 1>

That is, W′_{1,1,i}sW_{1,i}=W_{1,1,i}

Here, a w operator of Equation 1 is a Kronecker operator between vectors, and a value of an i-th element of W_{1,1} is obtained by the product of an i-th element of W′_{1,1} and an i-th element of W₁ like the following equation.

A weight vector that is considered here may be directly applied to the satellite antenna feeders 711, 712, 713, 714, and 715 of a satellite payload, and in a satellite system in which ground-based beam forming technology is introduced, a weight vector may be applied to a ground earth station.

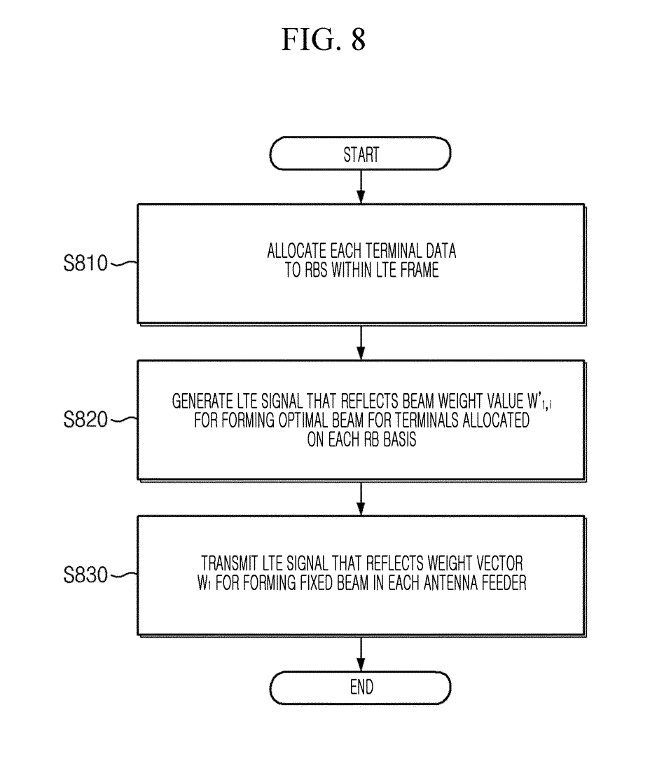

Thereby, a method of forming a beam according to another exemplary embodiment of the present invention that is described with reference to FIG. 8 is suggested.

That is, the method includes a step of allocating each terminal data to RBs within an LTE frame (S810), a step of generating an LTE signal that reflects a beam weight value W′_{1,i} for forming an optimal beam for terminals that are allocated on each RB basis (S820), and a step of transmitting an LTE signal by reflecting a weight vector W₁ for forming a fixed beam in each antenna feeder (S830).

In the foregoing description, a method of forming a specific adaptive beam in a resource to which the terminal is allocated in consideration of a position of the terminal in one beam has been described. However, in a multiple beam environment, a method of forming an adaptive beam in consideration of only a position of the terminal within one beam may cause serious interference in another beam that reuses the same frequency.

In consideration of such a case, a method of forming an adaptive beam and allocating a resource of a terminal in consideration of a multiple beam environment is suggested as follows.

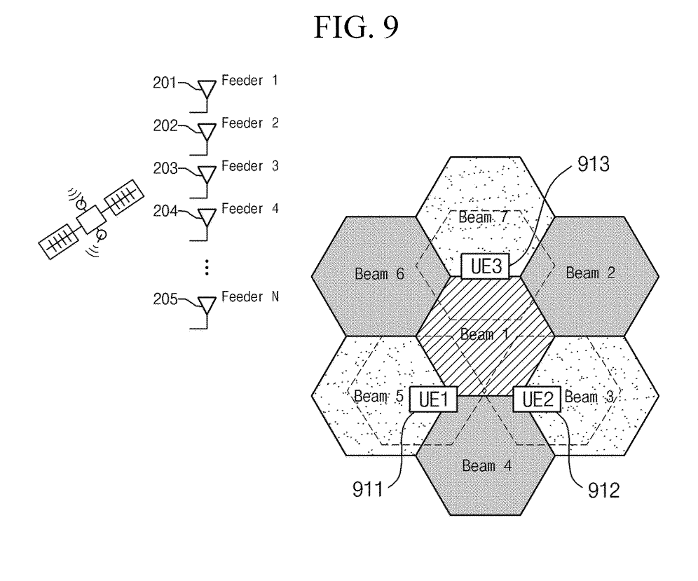

FIG. 9 is a block diagram illustrating a structure of a satellite antenna beam forming device in a multiple beam satellite system according to an exemplary embodiment of the present invention. FIG. 9 illustrates that frequency reuse is assumed as 3, and beams 3, 5, and 7 are an example of using the same frequency.

A beam that reuses the same frequency due to satellite antenna pattern characteristics should be disposed apart by a predetermined gap or more due to interference between beams. Therefore, a multiple beam satellite system generally uses frequency reuse larger than 1.

In FIG. 9, terminals 1, 2, and 3 (911, 912, and 913) to which a beam 1 is applied are positioned at a boundary area of beams 5, 3, and 7, respectively. When forming an adaptive beam in a resource that is allocated to each terminal, an adaptive beam that is indicated by a dotted line is formed.

However, in the adaptive beam, because a gap between beams decreases much less than an existing beam, the same frequency interference between the terminals 1, 2, and 3 (911, 912, and 913) becomes strong. That is, intensity of a signal according to a position of each terminal becomes strong through formation of the adaptive beam, but interference from another beam becomes strong and thus performance is deteriorated.

Therefore, in a multiple beam environment, in order to form an adaptive beam, formation of an adaptive beam that is considered in a multiple beam environment as well as a specific beam is formed, and resource allocation for relieving interference should be together performed.

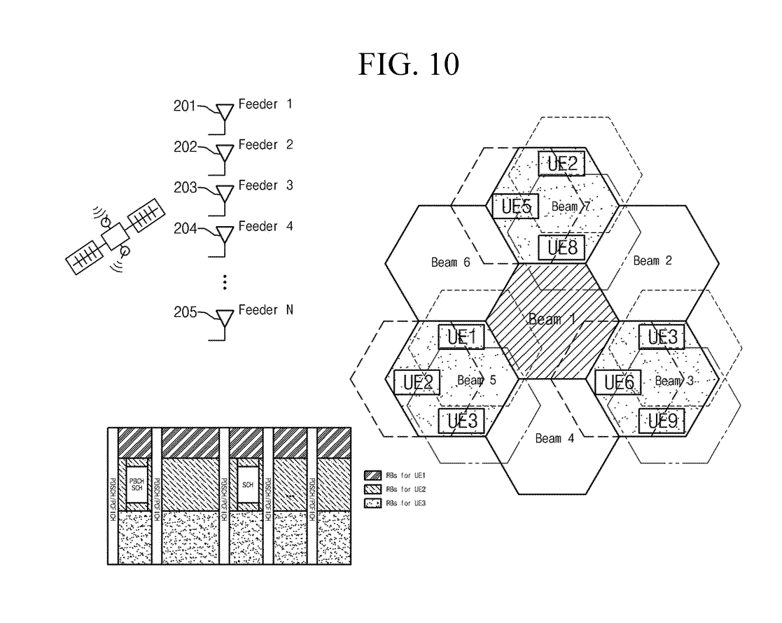

FIG. 10 is a block diagram illustrating a structure of a satellite antenna beam forming device in a multiple beam satellite system according to another exemplary embodiment of the present invention.

FIG. 10 illustrates a method of forming an adaptive beam and allocating a resource in consideration of interference between beams in a multiple beam environment that divides multiple beams using the same frequency with the same method in several areas and that forms an adaptive beam on an area basis, and that allocates only a specific RB group with the same method on each area basis.

That is, in FIG. 10, the beams 3, 5, and 7 use the same frequency, and the beam 1 uses a divided frequency, and beams 2, 4, and 6 use the differently divided same frequency.

The beams 3, 5, and 7 are divided into three areas with the same method. The number that divides an area may be changed according to a system embodiment scenario, but for a description, a method of dividing into three areas will be described.

RBs of an LTE frame are formed in a group to correspond to the number of divided areas, and an RB group is designated to the divided area. Terminals that are positioned at areas 1, 2, and 3 are previously formed in a group and are allocated to RB groups that are designated to each area.

In FIG. 10, RBs are formed in 3 groups, and the number of RBs of each group may be the same in every group or may be changed according to a traffic request amount of an area (e.g., many RBs are allocated to an area having much traffic, and few RBs are allocated to an area having less traffic, but it is preferable that the adjusted RB number for each group is simultaneously changed for a plurality of beams using the same frequency).

As described above, after an area is divided and RBs are formed in a group, an adaptive beam for improving performance on each area basis is formed.

That is, for example, in the beam 5, the area 1 reflects a beam forming weight vector W_{5,1} for improving performance in an area to an RB that is designated to the area 1. Further, by reflecting W_{5,2} to an RB that is designated to the area 2 and by reflecting W_{5,3} to an RB that is designated to the area 3, an adaptive beam is formed.

That is, as an area that divides a specific beam is designed so that interference with another beam does not occur (or so that interference with another beam occurs less), even if an adaptive beam that can increase intensity of signal strength according to a position is formed, performance degradation due to interference with another beam can be reduced.

Therefore, formation of a beam that is applied to the same RB in different beams using the same frequency maintain a gap similarly to an existing beam and thus interference between beams is relieved.

It should be determined whether the terminal is positioned at which area of a divided area of each beam, and RBs are allocated according to the determined position. A method of determining a position of the terminal may be performed through grouping of random access sequences, transmission of position information through a GPS, position grasping through intensity measurement of a downlink signal of an adjacent base station in the terminal, or uplink transmission of position information.

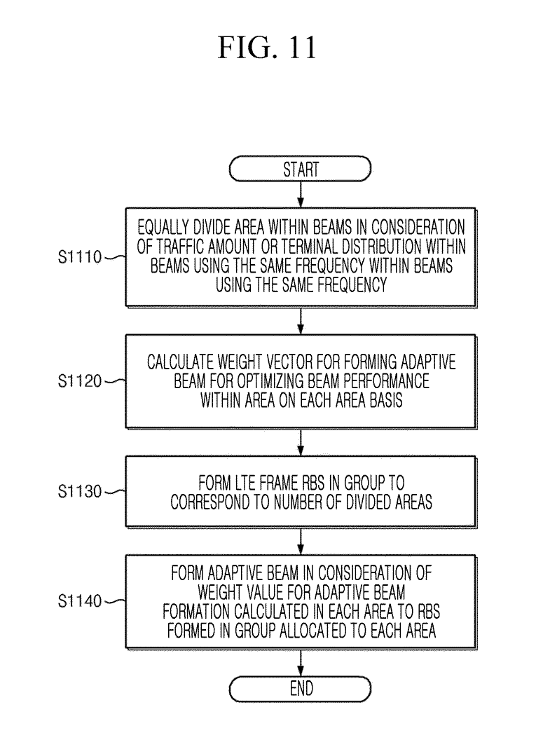

Thereby, a method of forming a beam according to another exemplary embodiment of the present invention that is described with reference to FIG. 11 is suggested.

The method includes a step of dividing an area within a beam in consideration of terminal distribution or a traffic amount within beams using the same frequency (S1110), a step of calculating a weight vector for forming an adaptive beam for optimizing a beam performance within an area on each area basis (S1120), a step of forming LTE frame RBs in a group to correspond to the divided area number (S1130), and a step of forming an adaptive beam in consideration of a weight value for adaptive beam formation that is calculated in each area to RBs that are formed in a group that is allocated to each area (S1140).

The present invention suggests a method of forming an adaptive beam that forms a beam that relieves interference and allocating a resource by grasping a position of interference coming from another beam in a satellite base station.

For example, a method of applying Equation 2 is considered.

max_{W}_{_{i,j}}_{,RB}_{ₖ} SINR_{i,j} <Equation 2>

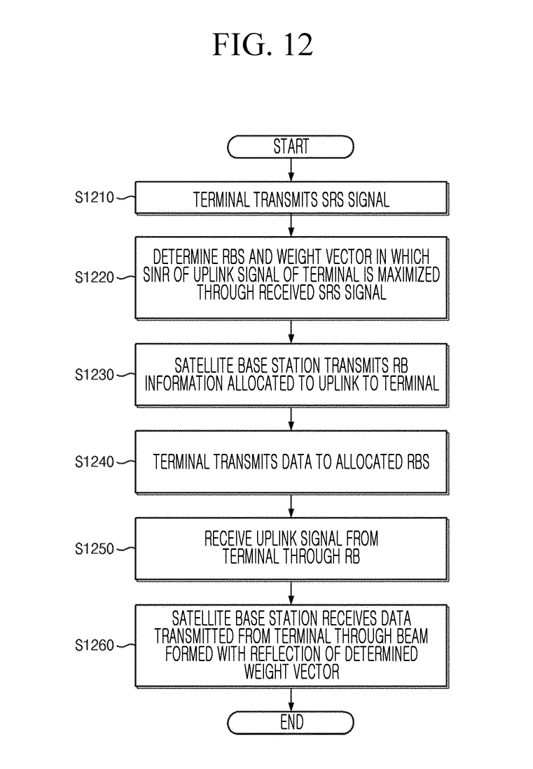

A method of determining an adaptive beam forming vector and an RB to allocate in a direction that maximizes an SINR of a j-terminal of an i-th beam like Equation 2 is suggested as a method that is described with reference to FIG. 12.

FIG. 12 is a flowchart illustrating a method of forming an adaptive beam and allocating a resource in an uplink according to an exemplary embodiment of the present invention.

Referring to FIG. 12, the terminal transmits a sounding reference signal (SRS) to the satellite base station (S1210).

Preferably, the terminal periodically transmits an SRS signal to the satellite base station. Further, the SRS signal does not control power for channel and interference estimation, unlike existing LTE.

The satellite base station determines an RB and a weight vector in which an SINR of an uplink signal of the terminal is maximized through the received SRS signal (S1220).

Preferably, the satellite base station determines an RB and a weight vector in which an SINR of an uplink signal of each terminal is maximized from an SRS signal that is received from each antenna feeder.

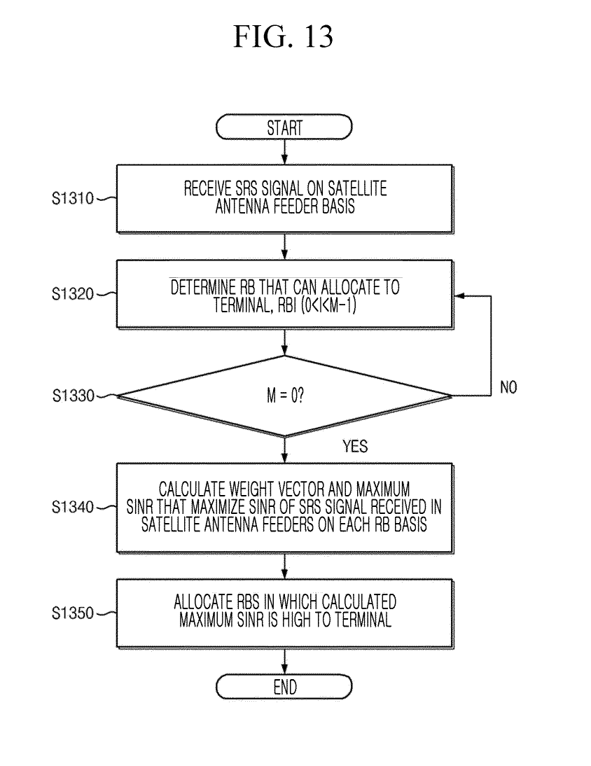

FIG. 13 is a flowchart illustrating a method of determining a weight vector and an RB in which a satellite base station maximizes an SINR of an uplink signal of a terminal according to an exemplary embodiment of the present invention.

Referring to FIG. 13, the satellite base station receives an SRS signal on satellite antenna feeder basis (S1310).

The satellite base station determines an RB that can allocate to the terminal (S1320).

That is, the satellite base station determines RBi (0<i<M−1) and determines whether M is 0 (S1330), and if M is not 0, step S1320 is performed.

The satellite base station calculates a weight vector and a maximum SINR that maximize an SINR of an SRS signal that is received on each RB basis (S1340).

The satellite base station preferentially allocates RBs in which the calculated maximum SINR is high to the terminal (S1350).

Thereby, the satellite base station may form an optimal beam in which interference is considered at a position of a terminal of each beam.

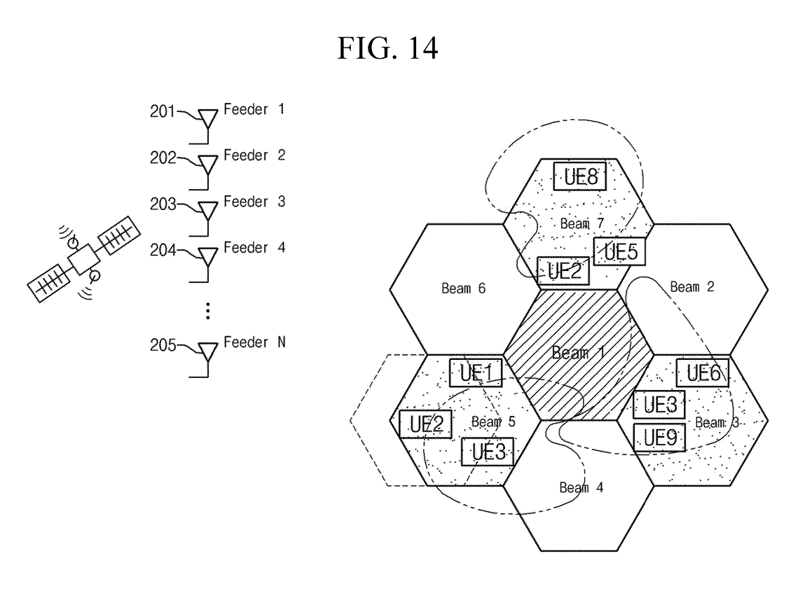

FIG. 14 is a diagram illustrating a multiple beam satellite system that operates by forming an optimal beam in consideration of interference from an adjacent beam or another network according to an exemplary embodiment of the present invention.

Referring again to FIG. 12, the satellite base station transmits RB information that is allocated to an uplink of the terminal through a downlink control channel so that the terminal transmits through the uplink (S1230).

The terminal transmits data to the allocated uplink RB through a downlink control channel (S1240).

The satellite base station receives an uplink signal from the terminal through a receiving beam that is formed through a weight vector (S1250).

Preferably, the satellite base station receives data that is transmitted from the terminal by detecting a received signal (S1260).

In the foregoing description, an exemplary embodiment and an application example of the present invention have been described, but the present invention is not limited to the specific exemplary embodiment and application example, and it will be apparent to those skilled in the art that various modifications and variations may be made without departing from the spirit or scope of the invention. Thus, it is intended that the present invention cover the modifications and variations of this invention provided they come within the scope of the appended claims and their equivalents.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a satellite base station forms a beam for communication with a terminal and allocates a resource, the method comprising
forming an adaptive beam and allocating a resource for relieving interference when a resource block (RB) is a channel that is allocated to a specific terminal.

2. The method of claim 1, wherein the channel that is allocated to the specific terminal is at least one of a physical downlink shared channel (PDSCH), a physical uplink shared channel (PUSCH), a reference signal (RS), and a physical uplink control channel (PUCCH).

3. The method of claim 1, wherein the forming of an adaptive beam comprises:
determining a position of the terminal;
calculating a weight vector that raises performance according to a position of the terminal; and
forming a beam by applying the weight vector to the RB.

4. The method of claim 3, wherein the performance is evaluated in consideration of a signal to interference and noise ratio (SINR) or a signal to noise ratio (SNR).

5. The method of claim 1, wherein the forming of an adaptive beam comprises:
dividing an area within a beam using the same frequency;
calculating a weight vector that increases performance in the divided area; and
forming an adaptive beam in consideration of the weight vector for a terminal that is positioned within the area.

6. The method of claim 5, wherein the dividing of an area within a beam comprises dividing the area in consideration of terminal distribution or a traffic amount within the beam.

7. The method of claim 5, wherein the forming of an adaptive beam comprises:
forming RBs in a group to correspond to the number of the divided areas; and
forming an adaptive beam by applying the calculated weight vector to the RBs that are formed in a group.

8. The method of claim 1, wherein the forming of an adaptive beam comprises:
receiving a sounding reference signal (SRS) from the terminal;
determining a weight vector and an RB in which an SINR of an uplink signal of the terminal is maximized through the received SRS signal;
transmitting information about an RB that is determined through a downlink control channel to the terminal;
transmitting data from the terminal to the RB; and
receiving an uplink signal through a beam that is formed through the weight vector from the terminal.

9. The method of claim 8, wherein the determining of a weight vector and an RB comprises:
determining an RB that can be allocated to the terminal;
calculating a maximum SINR and a weight vector that maximizes an SINR of an SRS signal that is received on an RB basis; and
preferentially allocating an RB in which the calculated maximum SINR is high to the terminal.
